(19) United States
(12) Patent Application Publication
(10) Pub. No.: US 2015/0122403 A1
(43) Pub. Date: May 7, 2015

(54) Display Device with Non-Transparent Heat Dissipating Layer and Manufacturing Method Thereof

(71) Applicant: AU Optronics Corporation, Hsin-Chu (TW)

(72) Inventors: Wen Hui Lee, Hsin-Chu (TW); Wu-Fa Chen, Hsin-Chu (TW); Yu-Chun Huang, Hsin-Chu (TW); Chao Ssun Hsieh, Hsin-Chu (TW); Ming-Pang Liu, Hsin-Chu (TW)

(21) Appl. No.: 14/534,253

(22) Filed: Nov. 6, 2014

(30) Foreign Application Priority Data
Nov. 7, 2013 (TW) 102140537

(51) Int. Cl. G02F 1/1333; H01J 7/24; G02F 1/1335

(52) U.S. Cl. CPC G02F 1/133382; G02F 1/133602; H01J 7/24; G02F 2001/133628
USPC 156/152; 156/252; 156/247; 349/161; 349/122; 362/373

(57) ABSTRACT

A display device and a manufacturing method thereof are provided. The display device includes a display module with a light emitting surface and a heat dissipating surface opposite to the light emitting surface. A non-transparent heat dissipating layer is affixed to the heat dissipating surface. A plurality of pre-split lines is formed on the non-transparent heat dissipating layer; the pre-split lines define a plurality of adjacent separable areas on the non-transparent heat dissipating layer. The non-transparent heat dissipating layer is affixed to the heat dissipating surface by an adhesive layer. When the display module needs to be repaired, at least one separable area may be torn off to form a window exposed on the heat dissipating surface.

### BACKGROUND OF THE INVENTION

1. Field of the Invention

The present invention provides a display device with a heat dissipating layer and a manufacturing method thereof.

2. Description of the Prior Art

The conventional self-emissive display such as organic light-emitting diode (OLED) display, field emission display (FED), and plasma display panel (PDP), has no external backlight module and generates images via the light emitting elements within the pixels of the panel. During displaying images, the heat generated by light emitting elements could directly accumulate under the panel so that the life time of the light emitting elements is shorten, further impacting on the light efficiency. In the current market, the supplier has developed the heat dissipating film in full piece type, the materials of the heat dissipating film may be graphite, aluminum, other metals or thermal conductive composite materials. Affixing the heat dissipating film to the back surface of the panel, the heat generated by the light emitting elements can be dissipated. Similarly, in the display device with backlight module such as liquid crystal display (LCD), the heat generated by the backlight module could be dissipated in a same manner.

The heat dissipating film in full piece type mentioned above is further combined with the panel through the adhesive layer disposed on the lower layer to dissipate the heat. However, in the back-end process, if abnormal events are found in the display areas, the abnormal areas are repaired by laser. At this point, if the heat dissipating film in full piece type such as the graphite heat dissipating film is not removed, then the laser energy will be absorbed by the graphite heat dissipating film and the abnormal areas cannot be repaired by the laser. If the whole graphite heat dissipating film is removed by external force, the graphite heat dissipating film may be damaged and cannot be reused, resulting in the increase in cost.

### SUMMARY OF THE INVENTION

In view of the above problems, the present invention provides a display device with a non-transparent heat dissipating layer and a manufacturing method thereof, especially a non-transparent heat dissipating layer with a small area which can be torn off and re-affixed.

In one aspect, the present invention provides a display device including a display module with a light emitting surface and a heat dissipating surface opposite to the light emitting surface. A non-transparent heat dissipating layer is affixed to the heat dissipating surface, and a plurality of pre-split lines are formed on the non-transparent heat dissipating layer to define a plurality of adjacent separable areas.

In another aspect, the present invention provides a display device including a display module with a light emitting surface and a heat dissipating surface opposite to the light emitting surface. A non-transparent heat dissipating layer is affixed to the heat dissipating surface, wherein after tearing off the separable areas on the non-transparent heat dissipating layer, the pre-split lines form a full gap and expose windows having the size corresponding to the torn off separable areas.

In another aspect, the present invention provides a method for manufacturing a display device including: forming a plurality of pre-split lines on a non-transparent heat dissipating layer to define a plurality of adjacent separable areas; and affixing the non-transparent heat dissipating layer to the heat dissipating surface by an adhesive layer.

Compared with the conventional technique, the display device with the heat dissipating layer of the invention can reduce the cost and simplify the process of tearing off and re-affixing the heat dissipating layer.

The following description and the drawings set forth certain illustrative advantages and spirits of the specification.

### BRIEF DESCRIPTION OF THE DRAWINGS

FIG. 1A is a schematic diagram of a display device in an embodiment.

FIG. 1B is a schematic backside view of a display device in an embodiment.

FIG. 2A is a schematic diagram of a graphite heat dissipating layer in an embodiment.

FIG. 2B is a schematic diagram of penetrating a graphite heat dissipating layer in an embodiment.

FIG. 3A is a schematic diagram of a heat dissipating layer in an embodiment.

FIG. 3B is a schematic top view of partially tearing off a heat dissipating layer in an embodiment.

FIG. 3C is a schematic top view of totally tearing off a heat dissipating layer in an embodiment.

FIG. 3D is a schematic diagram of a heat dissipating layer in another embodiment.

FIG. 4 is a schematic diagram of a display device in another embodiment.

FIG. 5 is a flow chart of a method for manufacturing a display device in an embodiment.

### DETAILED DESCRIPTION OF THE PREFERRED EMBODIMENT

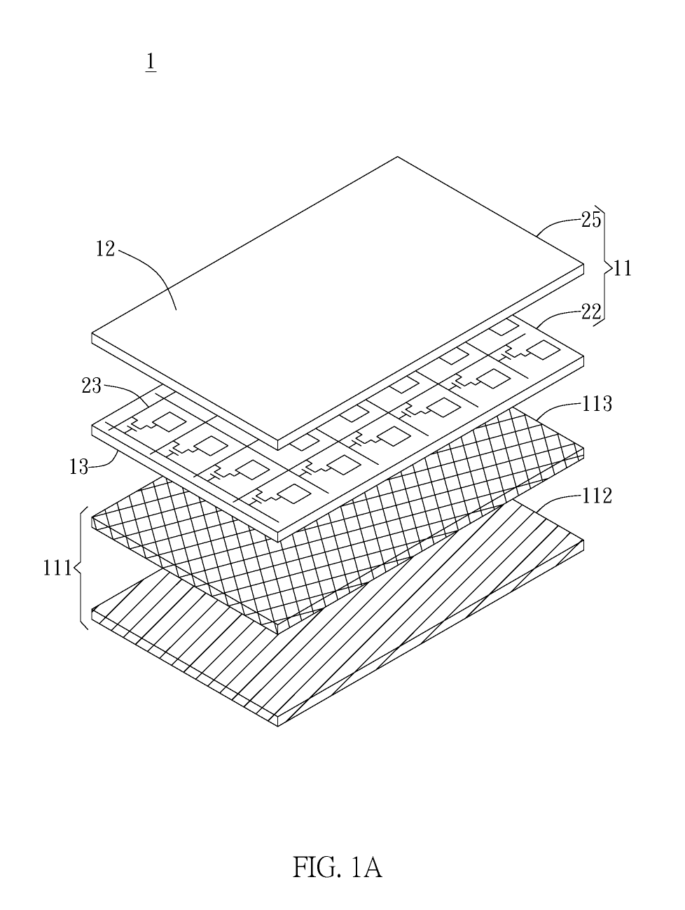

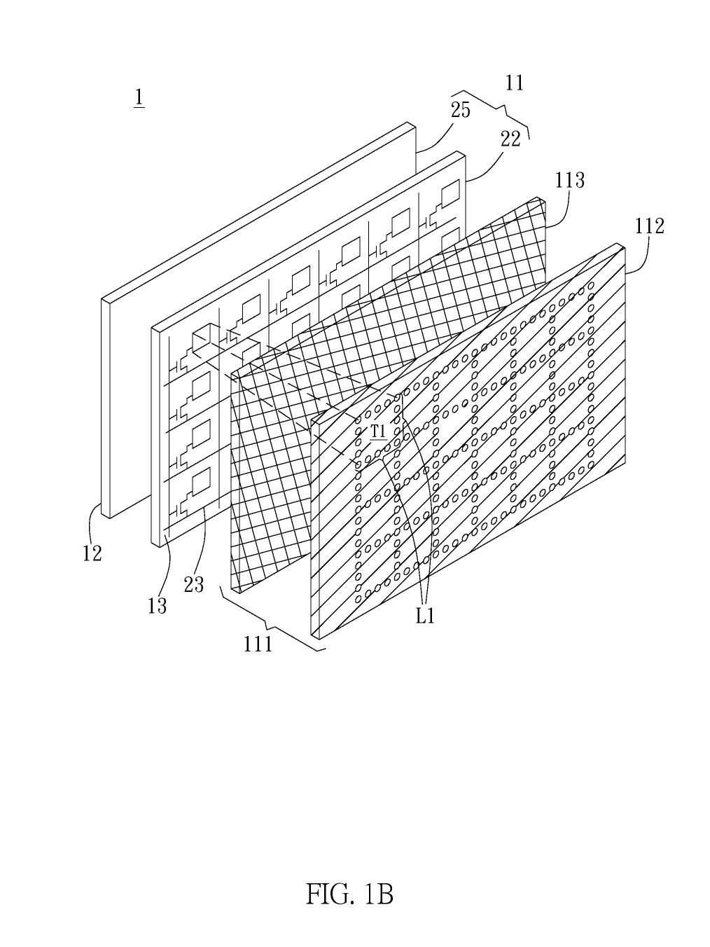

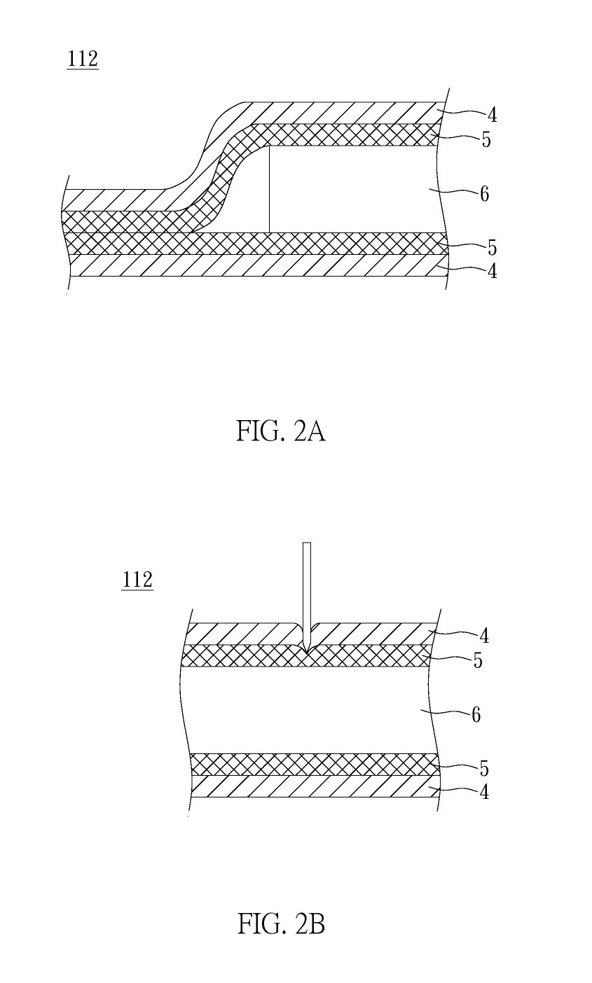

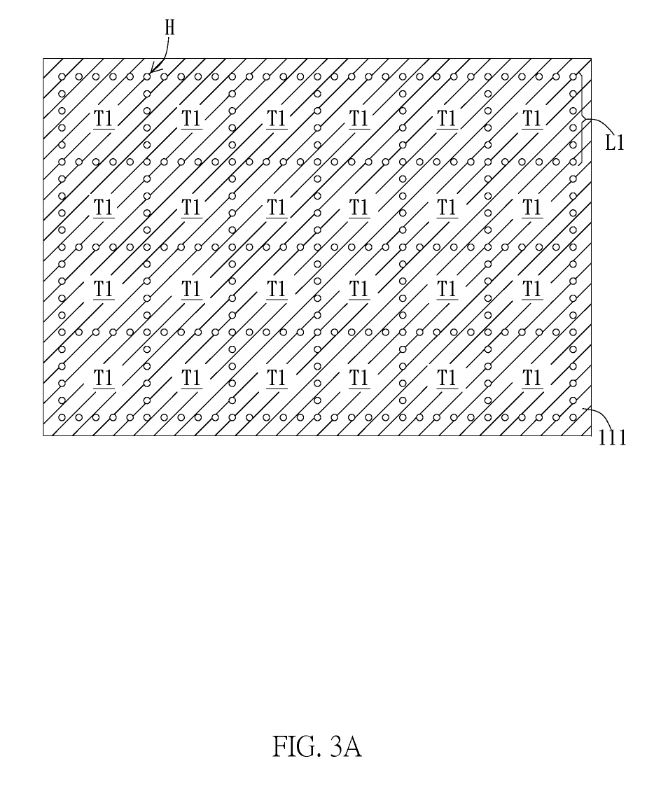

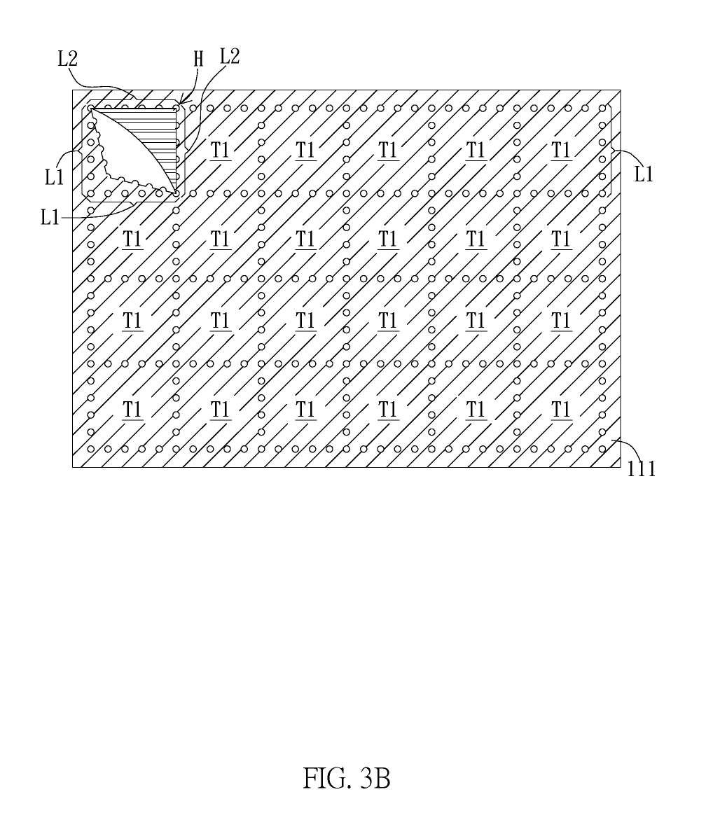

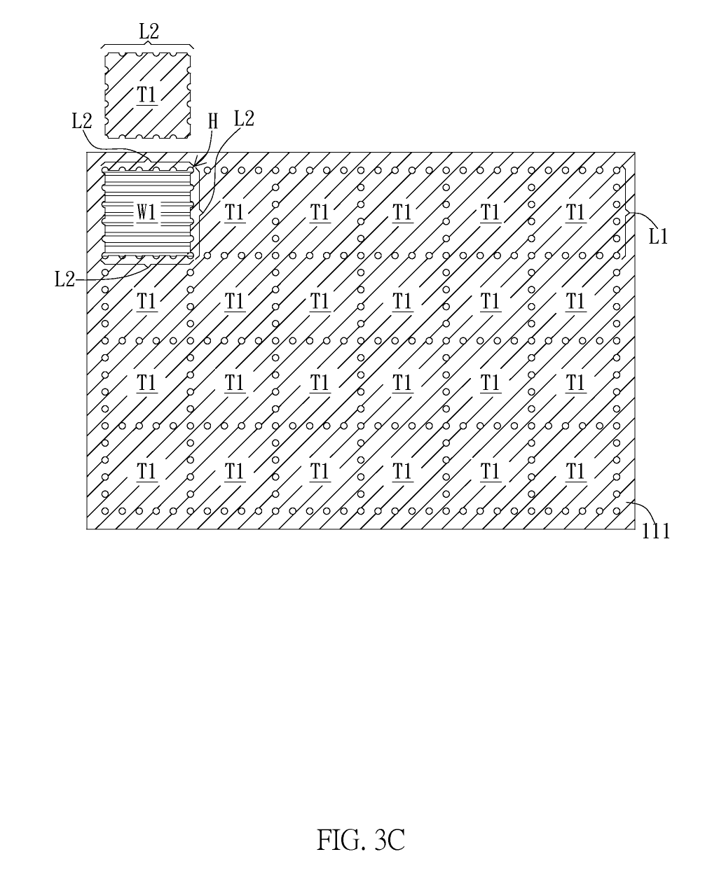

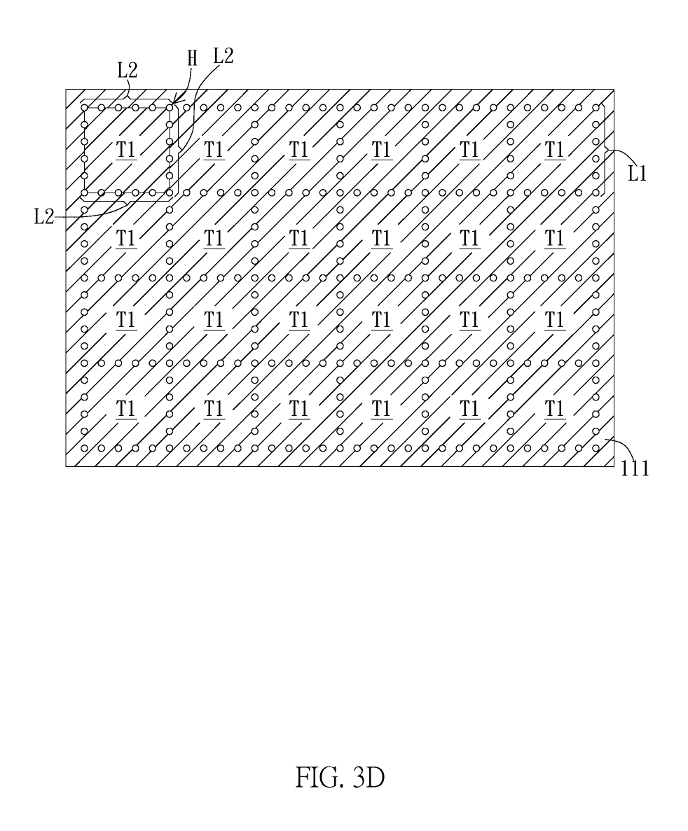

Referring to FIGS. 1A, 1B, 2A and 3A, FIG. 1A is a schematic diagram of a display device in an embodiment; FIG. 1B is a schematic backside view of a display device in the embodiment; FIG. 2A is a schematic diagram of a graphite heat dissipating layer in an embodiment; FIG. 3A is a schematic diagram of a heat dissipating layer in an embodiment. As shown in FIG. 1A, in the embodiment, the display device 1 includes a display module 11 and a non-transparent heat dissipating layer 111. The display module 11 includes a light emitting surface 12 and a heat dissipating surface 13 opposite to the light emitting surface 12. The non-transparent heat dissipating layer 111 is affixed to the heat dissipating surface 13. The non-transparent heat dissipating layer 111 preferably includes a heat dissipating body 112 and an adhesive layer 113. The adhesive layer 113 is disposed on the heat dissipating body 112 and affixes the heat dissipating body 112 to the heat dissipating surface 13.

In this embodiment, the display module 11 displays images preferably by use of the self-emissive component. That is, the display module 11 is a self-emissive display panel and preferably includes: a circuit substrate 22 having a circuit layer 23 and the self-emissive layer (not shown) disposed thereon and a top substrate 25 disposes on a side of the circuit layer 23 opposite to the circuit substrate 22. As shown in FIG. 1B, the heat dissipating surface 13 is formed on the back surface of the circuit substrate 22 opposite to the circuit layer 23. It is noted that the heat dissipating surface 13 is preferably transparent to light to allow the repairing laser to pass therethrough. The adhesive layer 113 is preferably reusable and has a certain structural strength to reduce the residual adhesive when tearing off the adhesive layer 113. However, in a different embodiment, a new adhesive layer may be coated on the heat dissipating body 112.

The material of the heat dissipating body 112 mentioned above could be graphite, aluminum, other metals or thermal conductive composite materials, wherein the exemplified thermal conductive composite material can be a stacked layer of graphite, aluminum and copper. In this embodiment, taking the graphite for example, as shown in FIG. 2A, a graphite layer 6 having a thickness of 0.5 mm is encapsulated by or sandwiched between two polyester (PET) layers 4. The graphite layer 6 and each polyester (PET) layer 4 are affixed to each other by an adhesive layer 5.

As shown in FIG. 1B and FIG. 3A, a plurality of pre-split lines L1 are formed on the non-transparent heat dissipating layer 111, and the plurality of pre-split lines L1 define a plurality of adjacent separable areas T1 on the non-transparent heat dissipating layer 111. Please refer to FIG. 1B, in this embodiment, the projection of the separable area T1 on the circuit substrate 22 falls within the circuit layer 23. Therefore, when any of the separable areas T1 is torn off, the corresponding circuit layer 23 could be seen through the light-transparent heat dissipating surface 13. In this embodiment, the pre-split line L1 includes a plurality of holes H or gaps H in discontinuous arrangement. It is noted that the plurality of pre-split lines L1 could also be practiced in other ways, e.g. indentations, cutting half of the depth, et al.

In another embodiment, the pre-split lines are preferably defined as at least partially cut off along the extension of line, e.g. not completely separated. Please refer to FIG. 3B; tearing off a small part of the separable area T1, at this point, part of the pre-split lines forms a completely cut off gap L2, but the separable area T1 is not completely separated.

However, in a different embodiment, the pre-split lines could be completely cut off. As shown in FIG. 3C, after completely tearing off the separable area T1, the pre-split lines form the completely cut off gap L2. At this point, a window W1 is formed to expose the heat dissipating surface 13, wherein the size of the window W1 corresponds to the separable area T1.

It is noted that the tensile strength of the pre-split lines L1 on the non-transparent heat dissipating layer 111 is less than the tensile strength of other positions on the non-transparent heat dissipating layer 111. The plurality of separable areas T1 can be in the shape of a rectangle, but not limited thereto. For example, the separable area T1 can be in the shape of a circle or a polygon. In addition, in order to easily tear off the separable areas T1, each separable area T1 is preferably greater than or equal to 1 cm². In this embodiment, each separable area T1 has an area about 10 cm×10 cm, but not limited thereto.

Please refer to FIG. 3C and FIG. 3D; after tearing off the separable area T1, the pre-split lines form the completely cut off gap L2, and the window W1 with a size corresponding to the separable area T1 is exposed on the heat dissipating surface 13, so that the circuit can be optically repaired through the window W1. After finishing the repairing of the circuit, the separable area T1 or a new piece of separable area (not shown) having the same size as the window W1 can be re-affixed or affixed to the window W1.

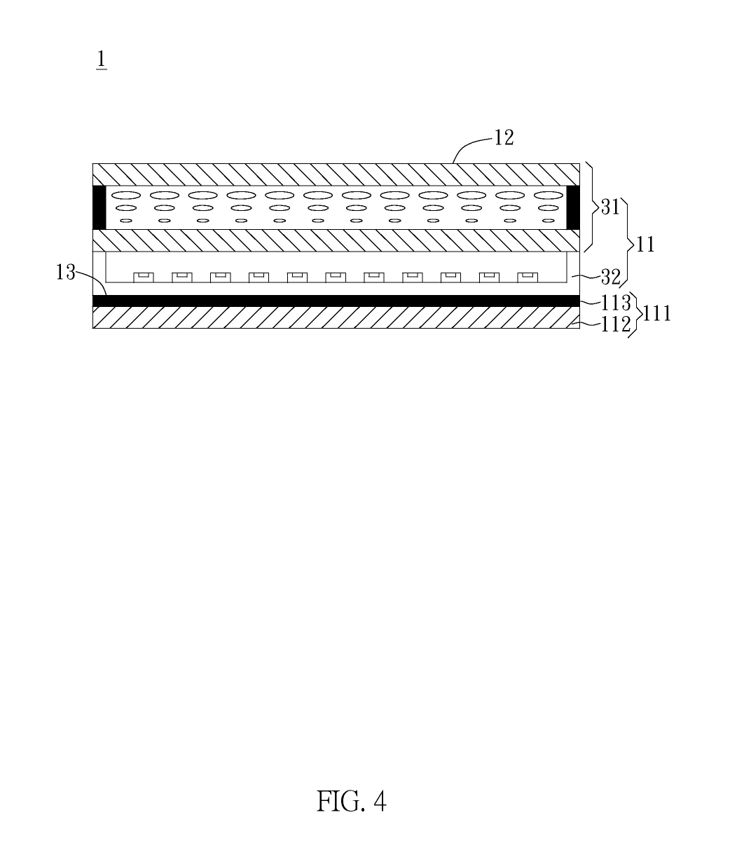

In another embodiment, please refer to FIG. 4; the display module 11 includes a liquid crystal display (LCD) panel 31 and a backlight module 32, wherein the heat dissipating surface 13 is formed on the bottom surface of the backlight module 32. It is noted that, in this embodiment, the non-transparent heat dissipating layer 111 is affixed to the bottom surface of the backlight module 32. The object to be optically repaired can be the backlight module 32. However, when the backlight module 32 has enough transparency or space, for example, when the direct-type backlight module is used, the circuit in the LCD panel 31 can be optically repaired through the backlight module 32. Furthermore, the side of the non-transparent heat dissipating layer 111 affixed to the backlight module 32 may have the reflective property so that the non-transparent heat dissipating layer 111 can also serve as a reflective layer of the backlight module 32 to reflect the leakage light from the bottom surface of the backlight module 32 to the backlight module 32 for reuse, resulting in the enhancement of light efficiency.

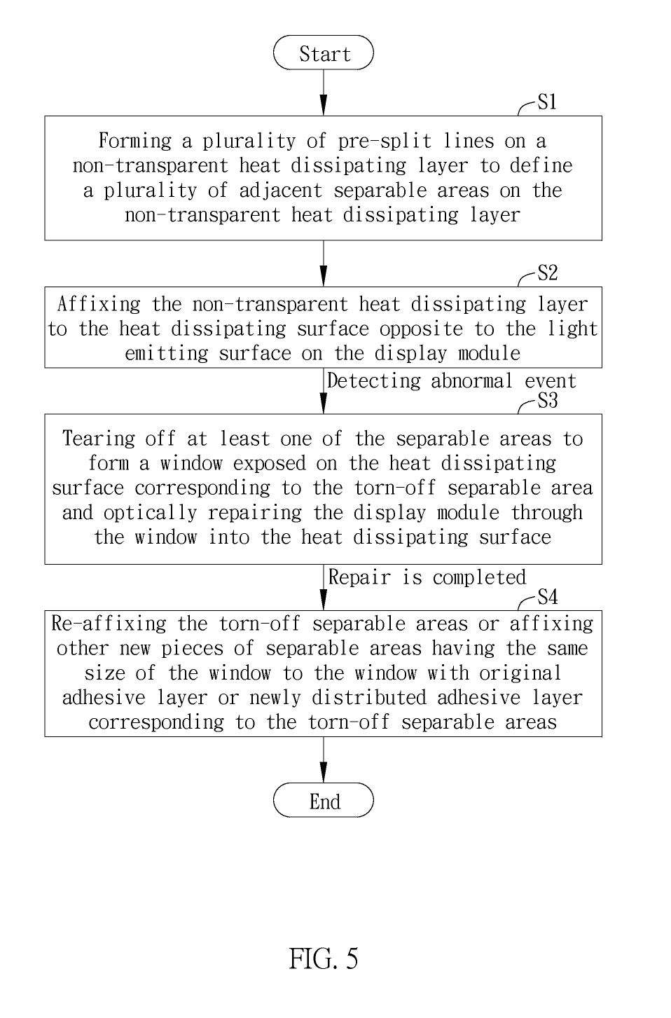

In another embodiment of the present invention, a method for manufacturing a display device is provided. As shown in FIG. 5, step S1 includes forming a plurality of pre-split lines by penetrating a non-transparent heat dissipating layer with punch, sawtooth knife or high power laser in heating or non-heating manner to define a plurality of adjacent separable areas on the non-transparent heat dissipating layer. Step S2 includes affixing the non-transparent heat dissipating layer to the heat dissipating surface opposite to the light emitting surface on the display module. Step S3 includes tearing off at least one of the separable areas to form a window exposed on the heat dissipating surface corresponding to the torn-off separable area and optically repairing the display module through the window into the heat dissipating surface. Step S4 includes re-affixing the torn-off separable areas or affixing other new pieces of separable areas having the same size of the window to the window with original adhesive layer or newly distributed adhesive layer corresponding to the torn-off separable areas. In this embodiment, the abnormal area of the display panel can be optically repaired by the Nd—YAG laser, but not limited thereto.

In the embodiment shown in FIG. 2B, the heat dissipating body 112 includes the graphite layer 6 and two polyester (PET) layers 4 covering the graphite layer 6 from upper and lower sides. In this structure, the graphite can be prevented from directly penetrating through. Furthermore, the heating punch will easily penetrate through the PET layer. After cooling, the upper and lower PET layers 4 may connect to each other to encapsulate the graphite to avoid the leakage of the graphite.

Compared with the prior art, the display device with a heat dissipating layer according to the present invention can reduce the cost and simplify the process of tearing off and re-affixing the heat dissipating layer in full piece type.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A display device, comprising:
a display module with a light emitting surface and a heat dissipating surface opposite to the light emitting surface; and
a non-transparent heat dissipating layer affixed to the heat dissipating surface;
wherein a plurality of pre-split lines are formed on the non-transparent heat dissipating layer, the plurality of pre-split lines on the non-transparent heat dissipating layer define a plurality of adjacent separable areas.

2. The display device of claim 1, wherein the display module comprises a self-emissive display panel, the self-emissive display panel comprises:
a circuit substrate having a circuit layer and a self-emissive layer disposed thereon; and
a top substrate disposed on a side of the circuit layer opposite to the circuit substrate;
wherein the heat dissipating surface is formed on a back surface of the circuit substrate opposite to the circuit layer and the projection of the plurality of separable areas on the circuit substrate falls within the circuit layer.

3. The display device of claim 1, wherein the display module comprises:
a liquid crystal display panel; and
a backlight module;
wherein the heat dissipating surface is formed on a bottom surface of the backlight module.

4. The display device of claim 1, wherein the non-transparent heat dissipating layer comprises:
a heat dissipating body; and
an adhesive layer disposed on the heat dissipating body and affixing the heat dissipating body to the heat dissipating surface, wherein the adhesive layer is reusable.

5. The display device of claim 1, wherein the plurality of pre-split lines include a plurality of holes or gaps in discontinuous arrangement.

6. The display device of claim 1, wherein the tensile strength of the non-transparent heat dissipating layer at the plurality of pre-split lines is less than the tensile strength of the non-transparent heat dissipating layer at other positions.

7. The display device of claim 1, wherein the plurality of separable areas are formed in a shape of rectangle, circle, or polygon.

8. The display device of claim 7, wherein each of the plurality of separable areas is greater than or equal to 1 cm².

9. The display device of claim 1, wherein the plurality of pre-split lines between at least one of the separable areas and the adjacent separable areas form a gap completely cut off.

10. A display device, comprising:
a display module including a light emitting surface and a heat dissipating surface opposite to the light emitting surface, wherein the heat dissipating surface has a window; and
a non-transparent heat dissipating layer affixed to the heat dissipating surface;
wherein a gap is completely cut off between a separable area corresponding to the window on the non-transparent heat dissipating layer and other positions on the non-transparent heat dissipating layer.

11. The display device of claim 10, wherein the display module comprises a self-emissive display panel, including:
a circuit substrate including a circuit layer and a self-emissive layer; and
a top substrate disposed on the side of the circuit layer opposite to the circuit substrate;
wherein the heat dissipating surface is formed on the back of the circuit substrate opposite to the circuit layer and the projection of the plurality of separable areas on the circuit substrate falls within the circuit layer.

12. The display device of claim 10, wherein the display module comprises:
a liquid crystal display panel; and
a backlight module;
wherein the heat dissipating surface is formed on the bottom surface of the backlight module.

13. The display device of claim 10, wherein the non-transparent heat dissipating layer comprises:
a body of the heat dissipating layer; and
an adhesive layer disposed on the body of the heat dissipating layer and affixing the body of the heat dissipating layer to the heat dissipating surface;
wherein the adhesive layer corresponding to the window is the same as the adhesive layer on other positions of the non-transparent heat dissipating layer.

14. The display device of claim 10, wherein the non-transparent heat dissipating layer comprises:
a body of the heat dissipating layer; and
an adhesive layer disposed on the body of the heat dissipating layer and affixing the body of the heat dissipating layer to the heat dissipating surface;
wherein the adhesive layer corresponding to the window has a different property with the adhesive layer on other positions of the non-transparent heat dissipating layer.

15. The display device of claim 10, wherein a plurality of pre-split lines are formed on the non-transparent heat dissipating layer; the plurality of pre-split lines on the non-transparent heat dissipating layer defines the plurality of adjacent separable areas, and at least one of the plurality of adjacent separable areas corresponds to the window.

16. The display device of claim 15, wherein the plurality of pre-split lines include a plurality of holes or gaps in a discontinuous arrangement.

17. The display device of claim 15, wherein the tensile strength of the plurality of pre-split lines on the non-transparent heat dissipating layer is less than the tensile strength of other positions on the non-transparent heat dissipating layer.

18. The display device of claim 15, wherein the plurality of separable areas are formed in a shape of a circle or a polygon.

19. The display device of claim 18, wherein the plurality of separable areas are greater than 1 cm².

20. A method for manufacturing a display device, comprising:
forming a plurality of pre-split lines on a non-transparent heat dissipating layer to define a plurality of adjacent separable areas on the non-transparent heat dissipating layer; and
affixing the non-transparent heat dissipating layer to a heat dissipating surface opposite to a light emitting surface on a display module.

21. The method for manufacturing a display device of claim 20, further comprising:
tearing off at least one of the plurality of separable areas to form a window exposed on the heat dissipating surface corresponding to the torn-off separable area; and
optically repairing the display module through the window into the heat dissipating surface.

22. The method for manufacturing a display device of claim 21, further comprising:
re-affixing the torn-off separable area to the window.

23. The method for manufacturing a display device of claim 22, wherein the step of re-affixing the torn-off separable area further comprises:
affixing the torn-off separable area or other new pieces of separable areas having the same size of the window to the window with original adhesive layer or newly distributed adhesive layer corresponding to the torn-off separable area.

24. The method for manufacturing a display device of claim 21, wherein the display module has a circuit substrate including a circuit layer and a self-emissive layer;
the step of affixing the non-transparent heat dissipating layer comprises:
affixing the non-transparent heat dissipating layer to a side of the circuit layer opposite to the circuit substrate, and making the projection of the plurality of separable areas on the circuit substrate falls within the circuit layer.

25. The method for manufacturing a display device of claim 21, wherein the step of optically repairing comprises:
repairing the circuit layer through the window and the circuit substrate by laser.
